(19) United States
(12) Patent Application Publication
(10) Pub. No.: US 2025/0159747 A1
(43) Pub. Date: May 15, 2025

(54) Preventing Radio Resource Control (RRC) State Mismatch between Network and User Equipment

(71) Applicant: Telefonaktiebolaget LM Ericsson (publ), Stockholm (SE)

(72) Inventors: Lian Araujo, Solna (SE); Icaro Leonardo Da Silva, Solna (SE); Alessio Terzani, Stockholm (SE); Mattias Bergström, Sollentuna (SE)

(21) Appl. No.: 18/577,483

(22) PCT Filed: Jun. 28, 2022
(86) PCT No.: PCT/SE2022/050640

§ 371 Date: Jan. 8, 2024

Related U.S. Application Data
(60) Provisional application No. 63/222,724, filed on Jul. 16, 2021.

(51) Int. Cl. H04W 76/19; H04W 76/27; H04W 84/04

(52) U.S. Cl. CPC H04W 76/19; H04W 76/27; H04W 84/042

(57) ABSTRACT

Method for a user equipment, UE, configured with user credentials for a plurality of public land mobile networks, PLMNs, including, while registered in first and second PLMNs, in a connected state for the second PLMN, and in a reduced-energy state for the first PLMN, transmit (620) to the second PLMN an indication that the UE wants to enter a reduced-energy state for the second PLMN, initiating (630) a timer upon transmitting the indication and initiating (660) a recovery procedure towards the second PLMN based on expiration of the timer without receiving a responsive message from the second PLMN. Other embodiments include a complementary method for a network node configured to operate in the second PLMN, as well as a UE and network node configured to perform such methods.

### TECHNICAL FIELD

The present disclosure generally relates to wireless networks and particularly relates to improved techniques for managing user equipment (UEs) that are configured with multiple user subscriptions to different public land mobile networks (PLMNs).

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that can communicate with 3GPP-standard-compliant network equipment, including E-UTRAN as well as UTRAN and/or GERAN, as the third-generation (“3G”) and second-generation (“2G”) 3GPP RANs are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one more cells, including cells 106, 111, and 115 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the SI interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user—and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMEs 134 and 138 via respective S6a interfaces.

In some embodiments, HSS 131 can communicate with a user data repository (UDR)-labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

FIG. 2 illustrates a block diagram of an exemplary control plane (CP) protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and user plane (UP), as well as other UP functions such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE does not belong to any cell, no RRC context has been established for the UE (e.g., in E-UTRAN), and the UE is out of UL synchronization with the network. Even so, a UE in RRC_IDLE state is known in the EPC and has an assigned IP address.

Furthermore, in RRC_IDLE state, the UE's radio is active on a discontinuous reception (DRX) schedule configured by upper layers. During DRX active periods (also referred to as “On durations”), an RRC_IDLE UE receives system information (SI) broadcast by a serving cell, performs measurements of neighbor cells to support cell reselection, and monitors a paging channel for pages from the EPC via an eNB serving the cell in which the UE is camping.

A UE must perform a random-access (RA) procedure to move from RRC_IDLE to RRC_CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)-a UE identity used for signaling between UE and network—is configured for a UE in RRC_CONNECTED state.

Currently the fifth generation (“5G”) of cellular systems, also referred to as New Radio (NR), is being standardized within the Third-Generation Partnership Project (3GPP). NR is developed for maximum flexibility to support multiple and substantially different use cases but shares many similarities with fourth-generation LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. In addition to RRC_IDLE and RRC_CONNECTED, the NR RRC layer also includes an RRC_INACTIVE state with properties similar to the “suspended” condition in LTE Rel-13.

3GPP is currently studying how to support UEs that can manage two or more concurrent subscriptions to different public land mobile networks (PLMNs), e.g., with multiple subscriber identity modules (i.e., Multi-SIM or MUSIM). A single UE having two or more subscriber credentials can “act” as different UE's according to which subscription is active at any given time. Even though certain UEs may have some of these capabilities, most operations are not optimized and there is currently no 3GPP-standardized support for multi-SIM.

### SUMMARY

One exemplary scenario is a UE in RRC_CONNECTED state in a second PLMN (i.e., to which the user subscribes) has to perform operations in a first PLMN, such as listen to paging, acquire broadcast SI, cell reselection, etc. There are two possible procedures that the UE can follow in this scenario. The first is known as “RRC switching procedure without leaving RRC_CONNECTED,” such as when the UE listens to paging in the first PLMN during short periods and then shortly switches back to second PLMN, while remaining in RRC_CONNECTED state in the second PLMN during the operation in the first PLMN.

The second is known as “RRC switching procedure for leaving RRC_CONNECTED,” such as when the UE initiates a service in the first PLMN (e.g., responding to paging) and thus cannot shortly switch back to the second PLMN, causing the UE to leave RRC_CONNECTED state in the second PLMN. However, there can be various problems, issues, and/or difficulties when the UE leaves RRC_CONNECTED state in the second PLMN in this manner.

Embodiments of the present disclosure provide specific improvements to operation of MUSIM-capable UEs in wireless networks, such as by facilitating solutions to overcome exemplary problems summarized above and described in more detail below.

Embodiments of the present disclosure include methods (e.g., procedures) for a UE (e.g., wireless device) configured with user credentials for a plurality of PLMNs.

These exemplary methods can include, while registered in first and second PLMNs, in a connected state for the second PLMN, and in a reduced-energy state for the first PLMN, transmitting to the second PLMN an indication that the UE wants to enter a reduced-energy state for the second PLMN. These exemplary methods can also include initiating a timer upon transmitting the indication. These exemplary methods can also include initiating a recovery procedure towards the second PLMN based on expiration of the timer without receiving a responsive message from the second PLMN.

In some embodiments, the reduced-energy state for the second PLMN is one of the following: RRC_IDLE; RRC_INACTIVE; or RRC_IDLE with stored context. In some embodiments, the recovery procedure comprises establishing, re-establishing, or setting up the connected state with the second PLMN. In some embodiments, the indication that the UE wants to enter a reduced-energy state for the second PLMN is included in a UJEAssistance Information message.

In some embodiments, these exemplary methods can also include receiving a timer value from the second PLMN in an RRCReconfiguration message or an RROResume message. The timer is initiated to the received timer value. In some embodiments, the timer value can be included in a series of nested information elements for a Multi-SIM configuration.

In some embodiments, these exemplary methods can also include, when the responsive message is received from the second PLMN while the timer is running, applying the contents of the responsive message and stopping the timer. In some of these embodiments, the responsive message indicates that the UE should enter the reduced-energy state for the second PLMN. In some of these embodiments, the responsive message is an RRORelease message or an RRO Reconfiguration message.

In some embodiments, the recovery procedure towards the second PLMN is a NAS recovery procedure. In some embodiments, initiating the recovery procedure can include entering a reduced-energy state for the second PLMN.

In some of these embodiments, the recovery procedure initiated towards the second PLMN is performed upon the expiration of the timer without receiving a responsive message from the second PLMN. In other words, the UE performs the recovery procedure upon initiation.

In other of these embodiments, these exemplary methods can also include entering the connected state for the first PLMN such that the recovery procedure initiated towards the second PLMN is pending, and performing the pending recovery procedure towards the second PLMN upon exiting the connected state for the first PLMN.

In some variants, these exemplary methods can also include the following operations: initiating a second timer associated with a pending recovery procedure, in response to entering the reduced-energy state for the second PLMN; stopping the second timer in response to performing one or more of the following while the second timer is running: exiting the connected state for the first PLMN, or responding to a page from the second PLMN; and in response to expiration of the second timer, transmitting to the first PLMN an indication that the UE wants to exit the connected state for the first PLMN.

In some variants, these exemplary methods can also include, upon expiration of the timer without receiving a responsive message from the second PLMN, performing one of the following:
disabling or stopping one or more timer triggers for the recovery procedure towards the second PLMN; or
refraining from taking action upon expiration of any of the timer triggers for the recover procedure towards the second PLMN.

In some embodiments, the recovery procedure towards the second PLMN is initiated further based on one of the following:
relative priorities of the first PLMN and the second PLMN; or
relative priorities of respective UE services in the first PLMN and the second PLMN. In some embodiments, these exemplary methods can also include, while the timer is running and the UE is in the connected state for the second PLMN, refraining from performing one or more of the following operations in the second PLMN: radio link monitoring (RLM), radio resource monitoring (RRM), measurement reporting, monitoring conditional reconfiguration conditions, and sending UEAssistance Information messages.

In some embodiments, the recovery procedure can be a non-access-stratum (NAS) recovery procedure and initiating the recovery procedure can include, upon expiration of the timer, the UE access stratum (AS) sending the UE NAS an indication of a reason or cause for entering the reduced-energy state for the second PLMN.

In some of these embodiments, the UE NAS refrains from completing the initiated recovery procedure towards the second PLMN until the UE exits the connected state for the first PLMN.

In other of these embodiments, the UE NAS initiates the recovery procedure towards the second PLMN. For example, initiating the recovery procedure based on expiration of the timer can include the following operations: upon expiration of the timer, the UE AS sending the UE NAS an indication that one or more timer triggers for the recovery procedure can be enabled; and the UE NAS enabling the one or more timer triggers. The UE NAS can initiate the recovery procedure upon expiration of any of the timer triggers.

In other of these embodiments, the UE AS can indicate, to the UE NAS, a reason or cause associated with a connection failure when the UE exits the connected state for the first PLMN. In such embodiments, the UE NAS initiates the recovery procedure upon receiving the reason or cause.

Other embodiments include methods (e.g., procedures) for a network node (e.g., base station, eNB, gNB, ng-eNB, en-gNB, etc., or components thereof) configured to operate in a second PLMN to manage a UE configured with user credentials for a plurality of PLMNs.

These exemplary methods can include, while the UE is registered in the second PLMN and in a first PLMN, and in a connected state for the second PLMN, receiving from the UE an indication that the UE wants to enter a reduced-energy state for the second PLMN. These exemplary methods can also include initiating a timer for the UE upon receiving the indication and refraining from performing one or more connected-state operations with the UE while the timer is running.

In some embodiments, these exemplary methods can also include sending, to the UE while the timer is running, a message responsive to the indication. In some of these embodiments, the responsive message indicates that the UE should enter the reduced-energy state. In some of these embodiments, the responsive message is an RR (Release message or an RRC Reconfiguration message.

In some embodiments, the reduced-energy state for the second PLMN is one of the following: RRC_IDLE; RRC_INACTIVE; or RRC_IDLE with stored context. In some embodiments, the indication that the UE wants to enter a reduced-energy state for the second PLMN is included in a UEAssistance Information message.

In some embodiments, these exemplary methods can also include sending the UE a timer value in an RRO Reconfiguration message or an RRCResume message. The timer is initiated to the timer value sent to the UE. In some embodiments, the timer value is included in a series of nested information elements for a Multi-SIM configuration.

In some embodiments, these exemplary methods can also include performing a recovery procedure with the UE after expiration of the timer. In some of these embodiments, the recovery procedure is a NAS recovery procedure. In some of these embodiments, the recovery procedure comprises establishing, re-establishing, or setting up the connected state with the UE. In some of these embodiments, these exemplary methods can also include receiving, from the UE after expiration of the timer, a further indication of a UE-initiated recovery procedure with the second PLMN. The recovery procedure can be performed in response to the further indication.

Other embodiments include UEs (e.g., wireless devices, IoT devices, etc. or component(s) thereof) and network nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RNNs to perform operations corresponding to any of the exemplary methods described herein.

These and other embodiments described herein can provide various benefits and/or advantages for operation of MUSIM UEs, including avoiding and/or preventing RRC state mismatch between a UE and one of the multiple PLMNs in which the MUSIM UE is concurrently registered. This can prevent loss of data and/or excessive delay in receiving and responding to network paging, which can happen when a such a mismatch occurs. Embodiments also facilitate network control of the UE RRC state, which is very desirable.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary LTE network architecture.

FIG. 2 shows an exemplary configuration of an LTE control plane (CP) protocol stack.

FIGS. 3-4 show high-level views of exemplary 5G/NR network architectures.

FIG. 5 is a flow diagram that illustrates an exemplary RRC state mismatch between a MUSIM UE and a PLMN.

FIG. 6 is a flow diagram of an exemplary method (e.g., procedure) for a UE (e.g., wireless device, IoT device, etc. or component(s) thereof), according to various embodiments of the present disclosure.

FIG. 7 is a flow diagram of an exemplary method (e.g., procedure) for a network node (e.g., eNB, gNB, ng-eNB, en-gNB, etc. or component(s) thereof), according to various embodiments of the present disclosure.

FIG. 8 shows a communication system according to various embodiments of the present disclosure.

FIG. 9 shows a UE according to various embodiments of the present disclosure.

FIG. 10 shows a network node according to various embodiments of the present disclosure.

FIG. 11 shows host computing system according to various embodiments of the present disclosure.

FIG. 12 is a block diagram of a virtualization environment in which functions implemented by some embodiments of the present disclosure may be virtualized.

FIG. 13 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP Fifth Generation (5G) NR network or an enhanced or evolved Node B (eNB/ng-eNB) in a 3GPP LTE network), base station distributed components (e.g., CU and DU), base station control—and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

3GPP Rel-10 supports bandwidths larger than 20 MHz. One important Rel-10 requirement is backward compatibility with Rel-8. As such, a wideband LTE Rel-10 carrier (e.g., >20 MHz) should appear as a plurality of carriers (“component carriers” or CCs) to a Rel-8 (“legacy”) terminal. Legacy terminals can be scheduled in all parts of the wideband Rel-10 carrier. One way to achieve this is by Carrier Aggregation (CA), whereby a Rel-10 terminal can receive multiple CCs, each preferably having the same structure as a Rel-8 carrier.

LTE dual connectivity (DC) was introduced in Rel-12. In DC, a UE in RRC_CONNECTED state consumes radio resources provided by at least two different network points connected to one another with a non-ideal backhaul. In LTE, these two network points may be referred to as a “Master eNB” (MeNB) and a “Secondary eNB” (SeNB). More generally, these can be called master node (MN) and secondary node (SN). DC can be viewed as a special case of CA, in which the aggregated carriers (or cells) are provided by network nodes that are physically separated and not connected via a robust, high-capacity connection.

In DC, the UE is configured with a Master Cell Group (MCG) associated with the MN and a Secondary Cell Group (SCG) associated with the SN. Each of the CGs is a group of serving cells that includes one MAC entity, a set of logical channels with associated RLC entities, a primary cell (PCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG, respectively. In non-DC operation (e.g., CA), SpCell refers to the PCell. An SpCell is always activated and supports physical uplink control channel (PUCCH) transmission and contention-based random access by UEs.

Several DC (or more generally, multi-connectivity) scenarios are also available in 5G/NR. These include NR-DC that is similar to LTE-DC discussed above, except that both the MN and SN (referred to as “gNBs”) employ the NR interface to communicate with the UE. In addition, various multi-RAT DC (MR-DC) configurations are available, in which one of the MN and SN use NR and the other of the MN and SN uses LTE.

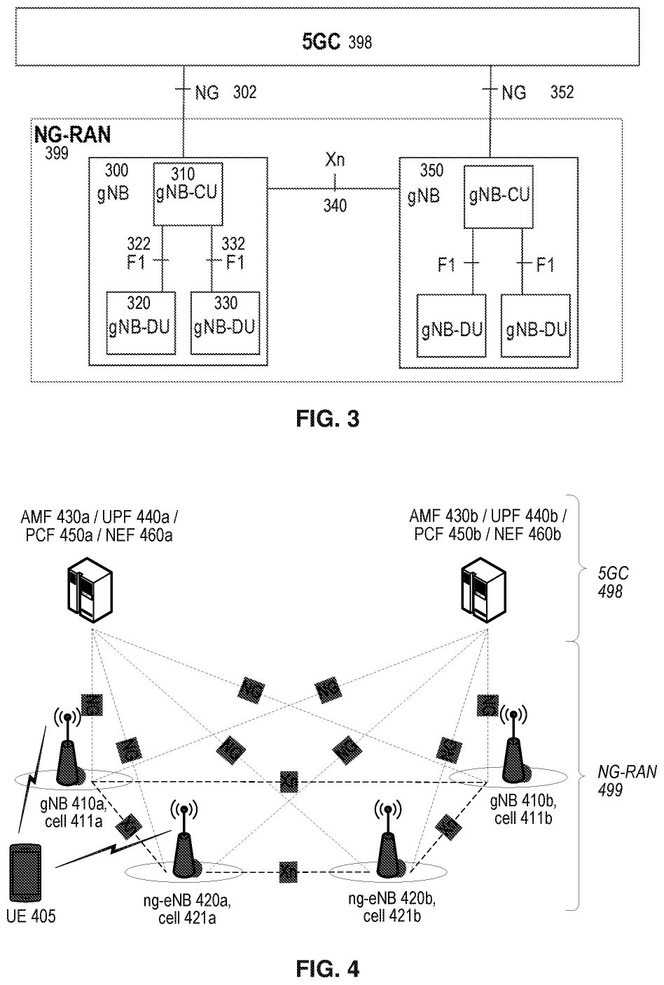

FIG. 3 illustrates a high-level view of an exemplary 5G network architecture, consisting of a Next Generation RAN (NG-RAN 399) and a 5G Core (5GC 398). NG-RAN 399 can include a set of gNodeB's (gNBs) connected to the 5GC via one or more NG interfaces, whereas the gNBs can be connected to each other via one or more Xn interfaces, such as Xn interface 340 between gNBs 300 and 350 in FIG. 3. Each of the gNBs can support frequency division duplexing (FDD), time division duplexing (TDD), or a combination thereof on the NR interface to UEs.

NG-RAN 399 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 3 include a central (or centralized) unit (CU or gNB-CU) and one or more distributed (or decentralized) units (DU or gNB-DU). For example, gNB 300 in FIG. 3 includes gNB-CU 310 and gNB-DUs 320 and 330. CUs are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry.

A gNB-CU connects to its associated gNB-DUs over respective F1 logical interfaces, such as interfaces 322 and 332 shown in FIG. 3. The gNB-CU and connected gNB-DUs are only visible to other gNBs and the 5GC as a gNB, e.g., the F1 interface is not visible beyond gNB-CU. In the gNB split CU-DU architecture illustrated by FIG. 3, DC can be achieved by allowing a UE to connect to multiple DUs served by the same CU or by allowing a UE to connect to multiple DUs served by different CUs.

FIG. 4 shows another high-level view of an exemplary 5G network architecture, including NG-RAN 499 and 5GC 498. As shown in the figure, NG-RAN 499 can include gNBs (e.g., 410a,b) and ng-eNBs (e.g., 420a,b) that are interconnected with each other via respective Xn interfaces. The gNBs and ng-eNBs are also connected via the NG interfaces to 5GC 498, more specifically to Access and Mobility Management Functions (AMFs, e.g., 430a,b) via respective NG-C interfaces and to User Plane Functions (UPFs, e.g., 440a,b) via respective NG-U interfaces. Moreover, the AMFs 430a,b can communicate with one or more policy control functions (PCFs, e.g., 450a,b) and network exposure functions (NEFs, e.g., 460a,b).

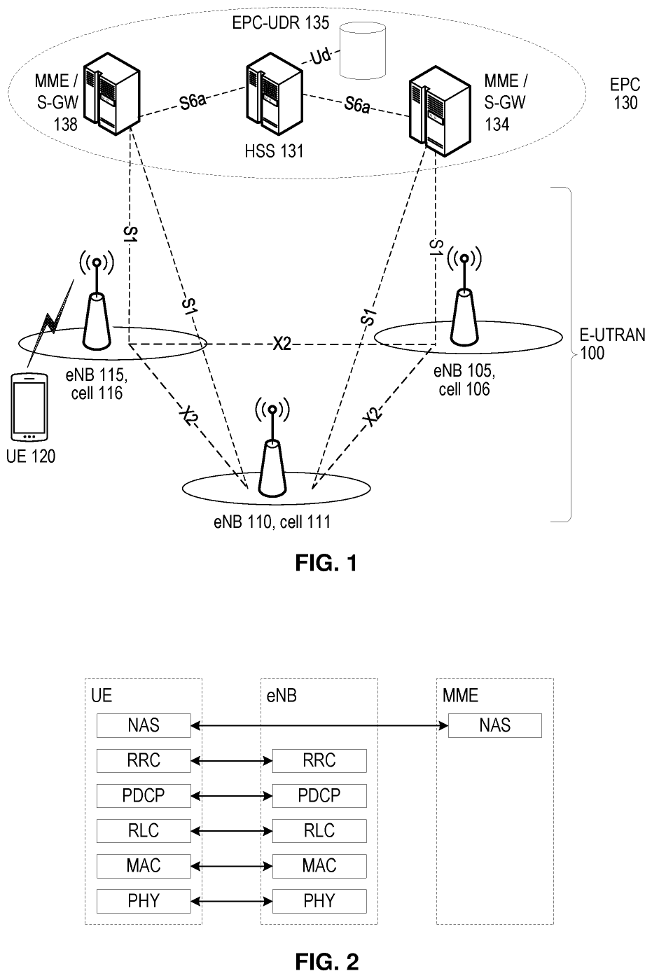

Each of the gNBs can support the NR radio interface including FDD, TDD, or a combination thereof. In contrast, each of ng-eNBs can support the LTE radio interface but, unlike conventional LTE eNBs (e.g., in FIG. 1), connect to the 5GC via the NG interface. Each or gNB or ng-eNB can serve a geographic coverage area including one more cells, such as cells 411a-b and 421a-b shown in FIG. 4. Depending on the cell in which it is located, a UE 405 can communicate with the gNB or ng-eNB serving that cell via the NR or LTE radio interface, respectively.

In some embodiments, the gNBs and ng-eNBs can also use various directional beams to provide coverage in the respective cells. In general, a DL “beam” is a coverage area of a network-transmitted reference signal (RS) that may be measured or monitored by a UE. In NR, for example, such RS can include any of the following, alone or in combination: synchronization signal/PBCH block (SSB), CSI-RS, tertiary reference signals (or any other sync signal), positioning RS (PRS), DMRS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state.

As briefly mentioned above, 3GPP is currently studying how to best support UEs that can manage two or more concurrent subscriptions to different public land mobile networks (PLMNs), e.g., with multiple subscriber identity modules (i.e., Multi-SIM or MUSIM). A single UE having two or more subscriber credentials can “act” as different UE's according to which subscription is active at any given time. Even though certain UEs may have some of these capabilities, most operations are not optimized and there is currently no 3GPP-standardized support for multi-SIM.

One possible improvement is an easier switch between states related to use of a first subscription to a first PLMN (with user credentials in a first USIM) and states related to use of a second subscription to a second PLMN (with user credentials in a second USIM). This can be particularly important when such states are dependent, e.g., CM-Connected in first and second PLMNs. Such switching may be straightforward, or even unnecessary, if the UE has the capability of communicating simultaneously with the first and second PLMNs using the first and second USIMs. This may require at least dual receiver and transmitter chains, frequencies that are used towards both networks don't interfere with each other, and radio separation is good enough to avoid interference (e.g., intermodulation, IM, effects) within the UE itself.

For UEs that cannot simultaneously communicate with two PLMNs in this manner, another possible approach is to introduce signaling that allows a UE to at least signal a network that it is leaving, or becoming unreachable for, a particular PLMN. One exemplary scenario is a UE in RRC_CONNECTED state in a second PLMN (i.e., to which the user subscribes) has to perform operations in a first PLMN, such as listen to paging, broadcast SI acquisition, cell reselection, etc.

There are two possible procedures that the UE can follow in this scenario. The first is known as “RRC switching procedure without leaving RRC_CONNECTED,” such as when the UE listens to paging in the first PLMN during short periods and then shortly switches back to second PLMN, while remaining in RRC_CONNECTED state in the second PLMN during the operation in the first PLMN. The second is known as “RRC switching procedure for leaving RRC_CONNECTED,” such as when the UE initiates a service in the first PLMN (e.g., responding to paging) and thus cannot shortly switch back to second PLMN, causing the UE to leave RRC_CONNECTED state in the second PLMN.

3GPP RAN2 working group has reached the following agreements on various switching-related issues:
Switching procedure can be used to notify the second PLMN (“network A”) that the UE has a preference to leave RRC_CONNECTED state in network A.
Switching procedure can be used to notify network A that the UE has a preference to be kept in RRC_CONNECTED state in network A while temporarily switching to the first PLMN (“network B”).
RRC signaling is used for switching procedure without leaving RRC_CONNECTED state in network A for UE temporarily switching to network B as a baseline. Need for additional MAC signaling is for further study (FFS).
During switching procedure for leaving RRC_CONNECTED state, the UE is allowed to enter RRC_IDLE state if it does not receive response message from network within a certain configured time period. This issue is FFS for RRC_INACTIVE state.
Access stratum (AS)-based solution for network switching includes two steps:
   If configured, UE can send an RRC message to leave RRC_CONNECTED for MUSIM purpose, and
   gNB may release the UE to RRC_IDLE/RRC_INACTIVE.

For the RRC switching procedure for leaving RRC_CONNECTED, the UE may be configured with a “leaving time period”, such that when the leaving time period is over, the UE may enter RRC_IDLE state even without having received an RRORelease message from the second PLMN (or network B).

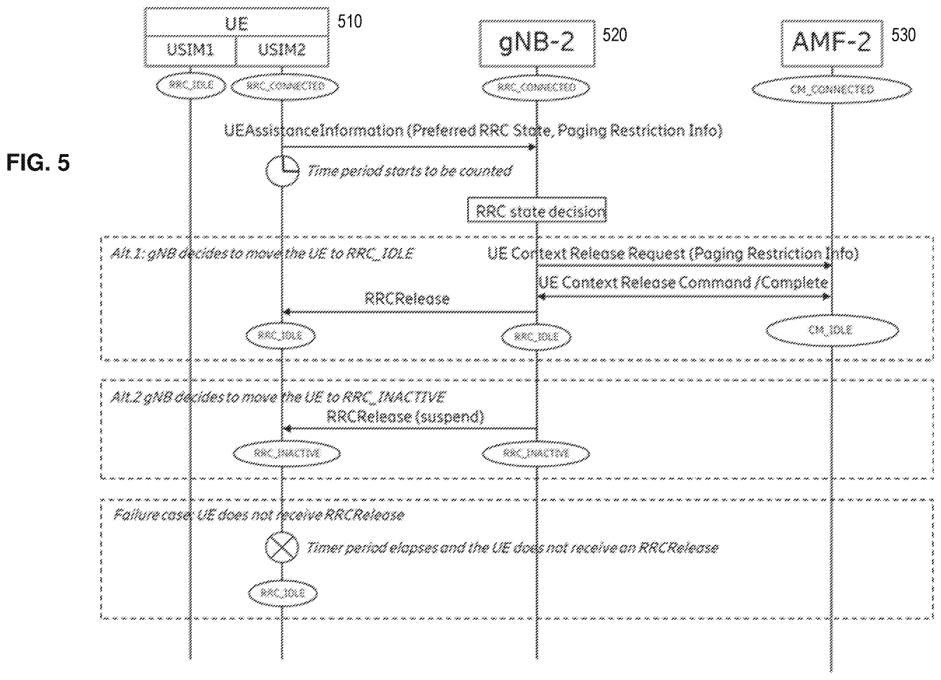

However, the leaving time period introduced for MUSIM may create a state mismatch between the UE and the network. FIG. 5 is a flow diagram that illustrates an exemplary RRC state mismatch between MUSIM UE and PLMN. The UE can indicate a preference to leave RRC_CONNECTED state by transmitting a (JEAssistanceInformation RRC message to its serving gNB (shown as gNB-2) in a second PLMN to which the user subscribes, indicating in the message a preference to enter RRC_INACTIVE or RRC_IDLE in the second PLMN. The UE can indicate that this is due to a MUSIM procedure in another PLMN, e.g., a first PLMN to which the user also subscribes. The UE can also indicate any paging restrictions. The UE starts a timer (e.g., “leaving timer”) that counts the leaving time period.

Three alternatives are shown in FIG. 5. In the first alternative, gNB-2 sends an RRCRelease message to move the UE to RRC_IDLE state, which the UE receives while during the leaving time period and transitions to RRC_IDLE accordingly. In the second alternative, gNB-2 sends an RRCRelease message with suspend indication to move the UE to RRC_INACTIVE state, which the UE receives while during the leaving time period and transitions to RRC_INACTIVE accordingly. In the third alternative, the UE does not receive an RRCRelease message during the UE's leaving time period (e.g., due to poor channel conditions), after which the UE transitions to RRC_IDLE state as specified. If gNB-2 intended the UE to be in RRC_INACTIVE instead, this creates a state mismatch between the UE and the network (e.g., second PLMN).

This state mismatch may cause various problems. For example, after the leaving time period the UE transitions to RRC_CONNECTED in the first PLMN while being in RRC_IDLE in the second PLMN. As such, the UE needs to monitor paging in the second PLMN according to the paging occasions configured for RRC_IDLE. However, the second PLMN (e.g., gNB-2) may still trigger RAN paging (rather than CN paging) for that UE, since it is assumed to be in RRC_INACTIVE. Hence, if the second PLMN needs to page the UE, there will be data from second PLMN's CN to the UE's last serving gNB (i.e., gNB-2), RAN paging in the RAN area, and a failed RAN paging before the second PLMN's CN may detect a failure to respond to RAN paging and trigger a CN paging. Some of the data will be lost and may require retransmission, but also the time to receive and respond to the paging (i.e., by the CN) will be much longer due to this state mismatch.

Accordingly, embodiments of the present disclosure provide techniques whereby a MUSIM UE, being simultaneously registered in first and second PLMNs, having corresponding first and second USIMs, and being in connected state in the second PLMN and in a reduced-energy state in the first PLMN, can perform various operations to avoid and/or prevent an RRC state mismatch between the UE and the second PLMN. For example, the UE can transmit an indication to the second PLMN indicating a preference to transition to a reduced-energy state and then start a timer. When the UE receives a message from the second PLMN while the timer is running, the UE can apply the received message and stop the timer. Upon expiration of the timer (i.e., without receiving the message), the UE can perform a recovery procedure towards the second PLMN. This facilitates expedited resynchronization with the second PLMN. Alternately, the UE can initiate the recovery procedure after it leaves the connected state in the second PLMN, such that the recovery procedure is pending when the timer expires.

Embodiments of the present disclosure can provide various benefits, advantages, and/or solutions to problems described herein. For example, embodiments can avoid and/or prevent RRC state mismatch between UE and network and/or can facilitate the network to be in control of the UE RRC state, which is very desirable.

Embodiments of the present disclosure will now be described in more detail. In this description, the term “first PLMN” will refer to a network in which the UE is registered and wants to switch from a reduced-energy state (e.g., RRC_INACTIVE or RRC_IDLE) to a connected or normal-energy state (e.g., RRC_CONNECTED). Likewise, the term “second PLMN” will refer to a network in which the UE is registered and transmits an indication that it wants to switch from a connected or normal-energy state (e.g., RRC_CONNECTED) to a reduced-energy state (e.g., RRC_INACTIVE or RRC_IDLE). The term “MUSIM UE” will refer to the UE that is registered in the first and second PLMNs (e.g., based on corresponding first and second USIMs with subscription credentials) and performs the corresponding operations.

In some embodiments, the MUSIM UE (arranged in the manner discussed above) can transmit an indication to the second PLMN indicating a preference to switch to a reduced-energy state, and then start a timer. When the UE receives a message from the second PLMN while the timer is running, the UE can apply the received message and stop the timer. Upon expiration of the timer (i.e., without receiving the message), the UE can perform a recovery procedure towards the second PLMN. Various aspects of the recovery procedure are described below.

In some embodiments, when initiating recovery procedure in the second PLMN, the UE may further inform the first PLMN that it could not switch to the first PLMN. This can be done, for example, by a busy indication procedure. The UE can also include a cause for not switching to the first PLMN, e.g., failure on another network.

In some embodiments, when a service on the second PLMN (e.g., ongoing voice call) has higher priority than a service in the first PLMN, the UE triggers NAS recovery on second PLMN before leaving to the first PLMN. On the other hand, when a service in the first PLMN (e.g., ongoing voice call) has higher priority than a service in the second PLMN, the UE does not trigger NAS recovery on second PLMN before leaving to the first PLMN. The UE may later trigger such NAS recovery, e.g., based on other solutions described herein. In some embodiments, these operations can be based on relative PLMN priorities rather than relative service priorities.

In some embodiments, the UE may return to the second PLMN due to paging received from this network or due to a requirement that, after leaving RRC_CONNECTED in the first PLMN, the UE shall trigger NAS recovery in the second PLMN, even if there is no data to be transmitted in the second PLMN.

In some embodiments, when a data inactivity timer is running, the UE stops it when the UE switches back to the second PLMN (e.g., enters RRC_IDLE in the first PLMN and RRC_CONNECTED in the second PLMN) before expiry of the data inactivity timer.

In some embodiments, upon expiry of the timer, if the UE did not receive the RRCRelease message from the second PLMN, the UE does not restart the data inactivity timer upon being scheduled, which is contrary to conventional behavior of restarting the data inactivity timer when the UE is scheduled. The UE may continue to run the data inactivity timer even if it enters on RRC_IDLE, such that, the data inactivity timer will eventually expire and the UE will trigger NAS recovery towards second PLMN in response. The data inactivity timer would again be restarted by the UE upon being scheduled if the UE switches back to the second PLMN (e.g., enters RRC_IDLE in the first PLMN and RRC_CONNECTED in the second PLMN).

In some embodiments, the UE receives an RRCRelease message (or some parameters such as I-RNTI, Next Hop chaining Counter (NCC), etc. that are typically included) from the second PLMN while in RRC_CONNECTED state and stores the message (or parameters) without immediately applying it/them. For example, the UE may receive such information embedded in an RRCReconfiguration message or an RRCResume message. When UE transmits the indication to the second PLMN that it wants to enter a reduced energy state (e.g., suspended to RRC_INACTIVE or released to RRC_IDLE) and starts the timer, when the UE has not received a responsive RRCRelease message upon expiration of the timer, the UE applies the stored RRCRelease message (or parameters) and enters RRC_INACTIVE state in the second PLMN. The UE then connects to the first PLMN, and upon release to RRC_IDLE or suspension to RRC_INACTIVE by the first PLMN, the UE may trigger a resume request to the second PLMN. In case, the UE was suspended in the second PLMN upon timer expiry, the UE's resume request may include a cause value indicating the resume is due to the UE switching back from the first PLMN. On the network side, in the second PLMN, the context may have been deleted so that the second PLMN responds with an RRC Setup (so UE goes to IDLE and performs fallback).

In a variant, upon timer expiry the UE does not enter RRC_INACTIVE or RRC_IDLE in the second PLMN but suspends its normal operation, so that when it leaves RRC_CONNECTED in the first PLMN (or, only if paging restriction was indicated, or if the UE sent a leaving message) it can trigger a re-establishment in the second PLMN so long as the UE context is still stored in the second PLMN. The re-establishment is generally quicker than a setup from RRC_IDLE to RRC_CONNECTED. If the UE context is not still stored, the second PLMN can trigger a fallback by responding to the UE's RRCReestablishmentRequest message with an RRCSetup message.

In a variant, upon timer expiry the UE does not enter RRC_INACTIVE or RRC_IDLE in the second PLMN but goes into a deactivated MCG power saving mode, so that when it leaves RRC_CONNECTED in the first PLMN (or, only if paging restriction was indicated, or if UE sent a leaving message) it can transmit a request to re-activate the MCG in the second PLMN. Re-activating the MCG should be quicker than a setup from RRC_IDLE to RRC_CONNECTED. In 3GPP Rel-17, a deactivated SCG mode of operation is being defined for a UE in MR-DC, which could be extended also for deactivated MCG. Even if the UE is not configured with MR-DC, the UE may send requests to deactivate the MCG and to subsequently re-activate the MCG in the second PLMN, including a cause indicating a need to respond to a request from the first PLMN.

In some embodiments, the recovery procedure performed by the UE towards the second PLMN is NAS recovery, which is a procedure triggered by higher layers (i.e., the NAS) in the UE. However, there needs to be some interaction between the AS (e.g., lower layers including RRC) and NAS in the UE for these operations. Some options are described below.

In some embodiments, when the timer expires, the AS indicates to the NAS that the reason to leave is due to a MUSIM procedure and/or a failure. Thus, by knowing this reason and that the UE is leaving RRC_CONNECTED in the second PLMN because it is going to RRC_CONNECTED in the first PLMN, the UE's NAS does not request NAS recovery until notified by the UE's AS that the UE left RRC_CONNECTED in the first PLMN. Hence, the NAS recovery procedure is considered pending in NAS until NAS is notified that the UE left RRC_CONNECTED in the first PLMN. This notification could be transparent to the UE's NAS for the second PLMN. For example, it could be an indication that it is possible now to trigger a pending procedure, such as a pending NAS recovery.

In other embodiments, when the timer expires, the AS (e.g., RRC layer) does not indicate failure to the NAS but considers a recovery procedure pending. Subsequently the UE becomes RRC_CONNECTED in the first PLMN, enters RRC_IDLE in the second PLMN, and performs actions according to these states. Upon subsequently leaving RRC_CONNECTED in the first PLMN, the AS indicate a failure to the NAS so that the NAS can trigger a NAS recovery.

In some embodiments, while a recovery procedure towards the second PLMN is pending, the UE continues to monitor CN paging according to its RRC_IDLE behavior. If the recovery procedure is pending but paging is triggered by the second PLMN, the UE responds to paging and the NAS will discard the pending NAS recovery (e.g., a type of overriding procedure).

In some embodiments, the UE has a second timer related to a pending recovery procedure towards the second PLMN. The UE initiates the second timer when the UE enters a reduced-energy state (e.g., RRC_IDLE or RRC_INACTIVE) in the second PLMN. When the second timer expires, the UE transmits an indication to the first PLMN that it needs to leave RRC_CONNECTED. The second timer is stopped when the UE leaves RRC_CONNECTED in the first PLMN and/or when it responds to paging in the second PLMN.

As mentioned above, the MUSIM UE (arranged in the manner discussed above) can transmit an indication to the second PLMN indicating a preference to switch to a reduced-energy state, and then start a timer. The UE's behavior while in RRC_CONNECTED state in the first PLMN and the timer is running can vary in different embodiments, since some procedures may not need to be started and/or continued since the UE would anyway leave second PLMN.

In some embodiments, the UE stops performing radio link monitoring (RLM) in the second PLMN upon transmitting the indication to the second PLMN and/or upon starting the timer. In some embodiments, when the UE continues RLM which triggers a radio link failure (RLF), the UE can either refrain from triggering a responsive re-establishment procedure in the second PLMN, or can hold the re-establishment procedure as pending such that it is not triggered until the UE leaves RRC_CONNECTED in the first PLMN.

In some embodiments, the UE stops performing radio resource management (RRM) measurements and/or evaluating triggering conditions for events in the measurement configuration upon transmitting the indication to the second PLMN and/or upon starting the timer. In a variant, the UE can continue evaluating triggering conditions for events in the measurement configuration but refrains from sending measurement reports associated to such events even upon fulfillment of associated triggering conditions.

In some embodiments, the UE stops monitoring and/or evaluating execution conditions for conditional reconfigurations (e.g., conditional PScell Addition, Conditional PScell Change, Conditional Handover, etc.) upon transmitting the indication to the second PLMN and/or upon starting the timer.

In some embodiments, the UE refrains sending further (EAssistance Information messages upon transmitting the indication to the second PLMN and/or upon starting the timer.

In some embodiments, the UE may refrain from initiating certain procedures related to the second PLMN while it is connected to the first PLMN. For example, when the UE is not connected to another network such as the first PLMN, the UE may perform a registration update procedure periodically towards the second PLMN, based on timer T3512 defined in 3GPP TS 24.501 (v17.3.0). However, when the UE is connected to the first PLMN, the UE may refrain from performing the registration update procedure towards the second PLMN. This may be implemented by the UE suspending or stopping a timer (e.g., T3512) such that the timer will not expire and trigger the registration procedure. Alternatively, the UE may allow the timer to run but refrain from performing the registration procedure upon expiration of the timer.

The present disclosure refers to various operations being performed by, towards, or with the first PLMN or the second PLMN. This can include performing such operations by, towards, or with a network node of the first PLMN or the second PLMN, such as a network node serving a cell to which a UE is connected.

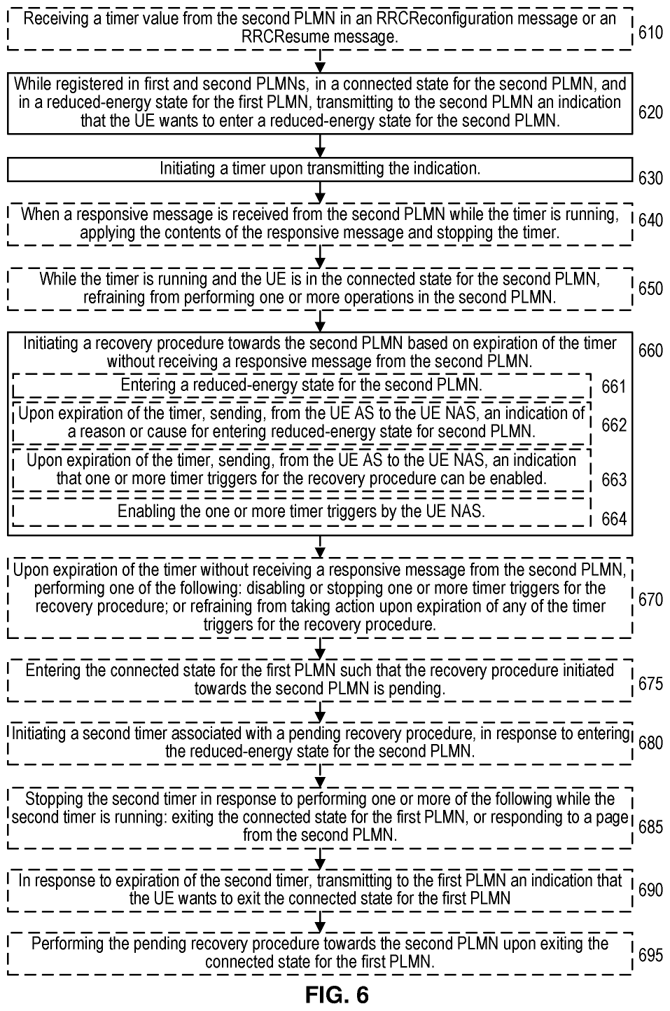

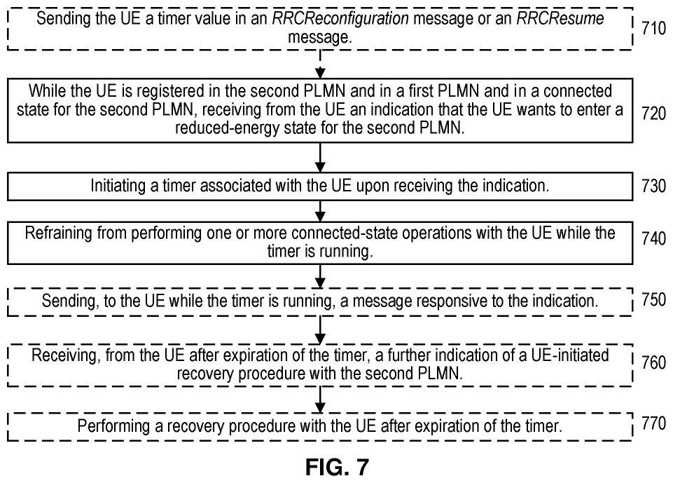

The embodiments described above can be further illustrated with reference to FIGS. 6-7, which show exemplary methods (e.g., procedures) for a UE and a network node, respectively. In other words, various features of operations described below correspond to various embodiments described above. These exemplary methods can be used cooperatively to provide various exemplary benefits and/or advantages. Although FIGS. 6-7 show specific blocks in a particular order, the operations of the respective methods can be performed in different orders than shown and can be combined and/or divided into blocks having different functionality than shown. Optional blocks or operations are indicated by dashed lines.

In particular, FIG. 6 shows a flow diagram of an exemplary method (e.g., procedure) for a UE configured with user credentials for a plurality of PLMNs, according to various embodiments of the present disclosure. The exemplary method can be performed by a UE (e.g., wireless device) such as described elsewhere herein.

The exemplary method can include operations of block 620, where while registered in first and second PLMNs, in a connected state for the second PLMN, and in a reduced-energy state for the first PLMN, the UE can transmit to the second PLMN an indication that the UE wants to enter a reduced-energy state for the second PLMN. The exemplary method can also include operations of block 630, where the UE can initiate a timer (e.g., a “leaving timer”) upon transmitting the indication. The exemplary method can also include operations of block 660, where the UE can initiate a recovery procedure towards the second PLMN based on expiration of the timer without receiving a responsive message from the second PLMN.

In some embodiments, the reduced-energy state for the second PLMN is one of the following: RRC_IDLE; RRC_INACTIVE; or RRC_IDLE with stored context. In some embodiments, the recovery procedure comprises establishing, re-establishing, or setting up the connected state with the second PLMN. In some embodiments, the indication that the UE wants to enter a reduced-energy state for the second PLMN is included in a UJEAssistanceInformation message.

In some embodiments, the exemplary method can also include operations of block 610, where the UE can receive a timer value from the second PLMN in an RROReconfiguration message or an RROResume message. The timer is initiated (e.g., in block 630) to the received timer value. In some embodiments, the timer value can be included in a series of nested information elements for a Multi-SIM configuration.

In some embodiments, the exemplary method can also include operations of block 640, where when the responsive message is received from the second PLMN while the timer is running, the UE can apply the contents of the responsive message and stop the timer. In some of these embodiments, the responsive message indicates that the UE should enter the reduced-energy state for the second PLMN. In some of these embodiments, the responsive message is an RR (Release message or an RR (Reconfiguration message.

In some embodiments, the recovery procedure towards the second PLMN is a NAS recovery procedure. In some embodiments, initiating the recovery procedure in block 660 can include the operations of sub-block 661, where the UE can enter a reduced-energy state for the second PLMN.

In some of these embodiments, the recovery procedure initiated towards the second PLMN is performed upon the expiration of the timer without receiving a responsive message from the second PLMN. In other words, the UE performs the recovery procedure upon initiation.

In other of these embodiments, the exemplary method can also include the operations of blocks 675 and 695, where the UE can enter the connected state for the first PLMN such that the recovery procedure initiated towards the second PLMN is pending, and perform the pending recovery procedure towards the second PLMN upon exiting the connected state for the first PLMN.

In some variants, the exemplary method can also include the operations of blocks 680-690. In block 680, the UE can initiate a second timer associated with a pending recovery procedure, in response to entering the reduced-energy state for the second PLMN. In block 685, the UE can stop the second timer in response to performing one or more of the following while the second timer is running: exiting the connected state for the first PLMN, or responding to a page from the second PLMN. In block 690, in response to expiration of the second timer, the UE can transmit to the first PLMN an indication that the UE wants to exit the connected state for the first PLMN.

In some variants, the exemplary method can also include the operations of block 670, where upon expiration of the timer without receiving a responsive message from the second PLMN, the UE can perform one of the following:
disabling or stopping one or more timer triggers for the recovery procedure towards the second PLMN; or
refraining from taking action upon expiration of any of the timer triggers for the recover procedure towards the second PLMN.

In some embodiments, the recovery procedure towards the second PLMN is initiated further based on one of the following:
relative priorities of the first PLMN and the second PLMN; or
relative priorities of respective UE services in the first PLMN and the second PLMN. In some embodiments, the exemplary method can also include the operations of block 650, where while the timer is running and the UE is in the connected state for the second PLMN, the UE can refrain from performing one or more of the following operations in the second PLMN: radio link monitoring (RLM), radio resource monitoring (RRM), measurement reporting, monitoring conditional reconfiguration conditions, and sending (JEAssistanceInformation messages.

In some embodiments, the recovery procedure can be a non-access-stratum (NAS) recovery procedure and initiating the recovery procedure in block 660 can include the operations of sub-block 662, where upon expiration of the timer, the UE access stratum (AS) can send the UE NAS an indication of a reason or cause for entering the reduced-energy state for the second PLMN.

In some of these embodiments, the UE NAS refrains from completing the initiated recovery procedure towards the second PLMN until the UE exits the connected state for the first PLMN.

In other of these embodiments, the UE NAS initiates the recovery procedure towards the second PLMN. For example, initiating the recovery procedure based on expiration of the timer in block 660 can include the operations of sub-blocks 663-664. In sub-block 663, upon expiration of the timer, the UE AS can send the UE NAS an indication that one or more timer triggers for the recovery procedure can be enabled. In sub-block 664, the UE NAS can enable the one or more timer triggers. The UE NAS can initiate the recovery procedure upon expiration of any of the timer triggers.

In other of these embodiments, the UE AS can indicate, to the UE NAS, a reason or cause associated with a connection failure when the UE exits the connected state for the first PLMN. In such embodiments, the UE NAS initiates the recovery procedure upon receiving the reason or cause.

In addition, FIG. 7 shows a flow diagram of an exemplary method (e.g., procedure) for a network node configured to operate in a second PLMN and to manage a UE configured with user credentials for a plurality of PLMNs, according to various embodiments of the present disclosure. The exemplary method can be performed by a network node (e.g., base station, eNB, gNB, ng-eNB, en-gNB, etc., or components thereof) such as described elsewhere herein.

The exemplary method can include operations of block 720, where while the UE is registered in the second PLMN and in a first PLMN, and in a connected state for the second PLMN, the network node can receive from the UE an indication that the UE wants to enter a reduced-energy state for the second PLMN. The exemplary method can also include operations of block 730, where the network node can initiate a timer (e.g., a “leaving timer”) associated with the UE upon receiving the indication. The exemplary method can also include operations of block 740, where the network node can refrain from performing one or more connected-state operations with the UE while the timer is running.

In some embodiments, the exemplary method can also include operations of block 750, where the network node can send, to the UE while the timer is running, a message responsive to the indication. In some of these embodiments, the responsive message indicates that the UE should enter the reduced-energy state. In some of these embodiments, the responsive message is an RRCRelease message or an RRCReconfiguration message.

In some embodiments, the reduced-energy state for the second PLMN is one of the following: RRC_IDLE; RRC_INACTIVE; or RRC_IDLE with stored context. In some embodiments, the indication that the UE wants to enter a reduced-energy state for the second PLMN is included in a (JEAssistanceInformation message.

In some embodiments, the exemplary method can also include operations of block 710, where the network node can send the UE a timer value in an RRC′Reconfiguration message or an RRCResume message. The timer is initiated (e.g., in block 730) to the timer value sent to the UE. In some embodiments, the timer value is included in a series of nested information elements for a Multi-SIM configuration.

In some embodiments, the exemplary method can also include operations of block 770, where the network node can perform a recovery procedure with the UE after expiration of the timer. In some of these embodiments, the recovery procedure is a non-access stratum (NAS) recovery procedure. In some of these embodiments, the recovery procedure comprises establishing, re-establishing, or setting up the connected state with the UE. In some of these embodiments, the exemplary method can also include the operations of block 760, where the 35 network node can receive, from the UE after expiration of the timer, a further indication of a UE-initiated recovery procedure with the second PLMN. The recovery procedure can be performed (e.g., in block 770) in response to the further indication.

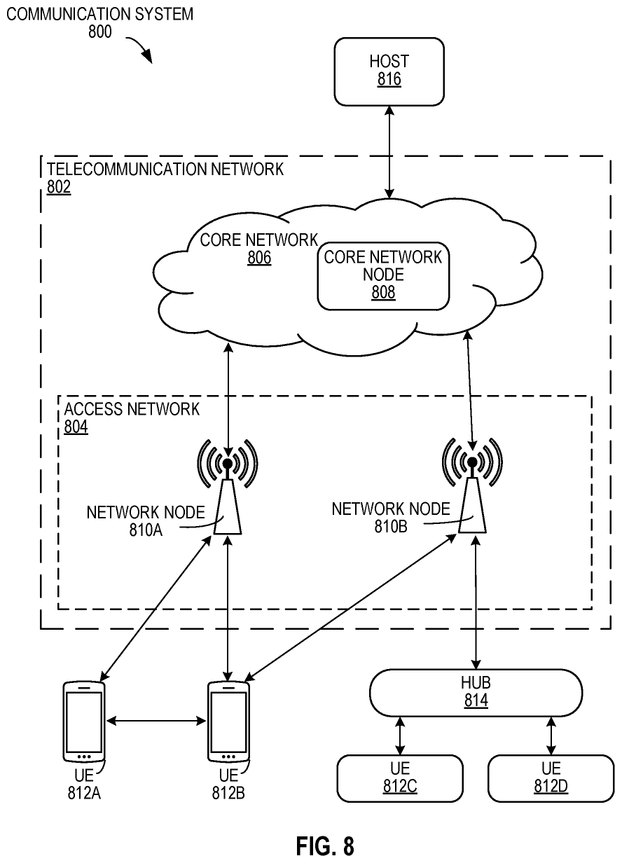

FIGS. 8-13 show various communication systems, network nodes, and UEs in which various embodiments of the present disclosure can be implemented.

In particular, FIG. 8 shows an example of a communication system 800 in accordance with some embodiments. In this example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3GPP access node or non-3GPP access point. The network nodes 810 facilitate direct or indirect connection of UEs, such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile

Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service 30) provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

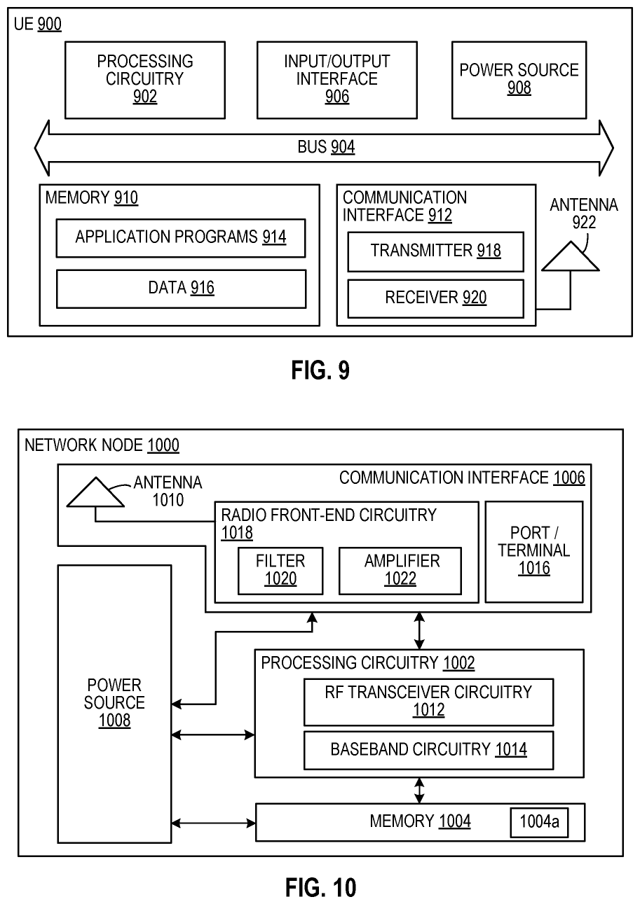

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together 35 with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing 30) Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions (collectively denoted computer program product 1004a) capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 can be integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

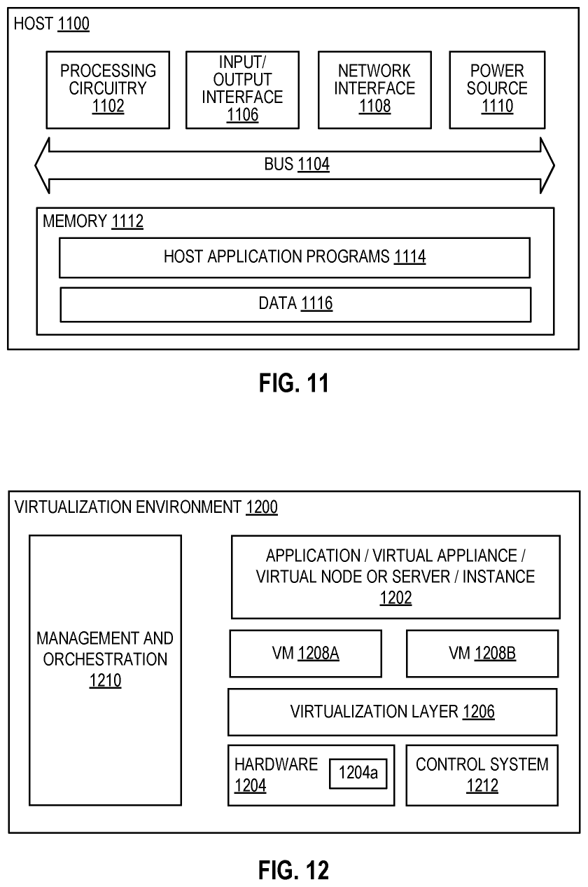

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more 25 virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions (collectively denoted computer program product 1204a) executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

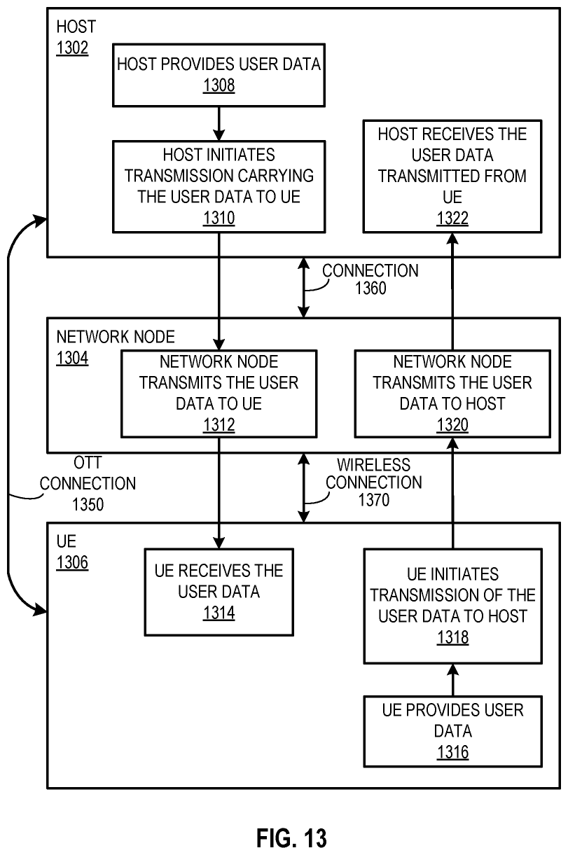

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, embodiments described herein can provide various benefits and/or advantages for operation of MUSIM UEs, including avoiding and/or preventing RRC state mismatch between a UE and one of the multiple PLMNs in which the MUSIM UE is concurrently registered. This can prevent loss of data and/or excessive time to receive and respond to network paging, which can happen when a such a mismatch occurs. Embodiments also facilitate the network to be in control of the UE RRC state, which is very desirable. At a high level, embodiments facilitate more consistent operation of UEs and networks, which increases the value of OTT services provided to UEs over such networks to both end users and OTT service providers.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured with user credentials for a plurality of public land mobile networks (PLMNs), the method comprising:
   while registered in first and second PLMNs, in a connected state for the second PLMN, and in a reduced-energy state for the first PLMN, transmitting to the second PLMN an indication that the UE wants to enter a reduced-energy state for the second PLMN;
   initiating a leaving timer upon transmitting the indication; and
   initiating a recovery procedure towards the second PLMN based on expiration of the leaving timer without receiving a responsive message from the second PLMN.
A2. The method of embodiment A1, wherein the reduced-energy state for the second PLMN is one of the following: RRC_IDLE; RRC_INACTIVE; or RRC_IDLE with stored context.
A3. The method of embodiment A1, further comprising receiving a timer value from the second PLMN in an RRCReconfiguration message or an RRCResume message, wherein the leaving timer is initiated to the received timer value.
A4. The method of embodiment A3, wherein the timer value is included in a series of nested information elements for a Multi-SIM configuration.
A5. The method of embodiment A1, wherein the indication that the UE wants to enter a reduced-energy state for the second PLMN is included in a UEAssistanceInformation message.
A6. The method of any of embodiments A1-A5, further comprising, when the responsive message is received from the second PLMN while the leaving timer is running, applying the contents of the responsive message and stopping the leaving timer.
A7. The method of embodiment A6, wherein the responsive message indicates that the UE should enter the reduced-energy state.
A8. The method of any of embodiments A6-A7, wherein the responsive message is one of the following: an RRCRelease message, or an RRCReconfiguration message.
A9. The method of any of embodiments A1-A8, wherein initiating the recovery procedure includes entering a reduced-energy state for the second PLMN.
A10. The method of any of embodiments A1-A9, wherein the recovery procedure towards the second PLMN is a Non-Access Stratum (NAS) recovery procedure.
A11. The method of any of embodiments A1-A10, wherein the recovery procedure towards the second PLMN is performed when the leaving timer expires.
A12. The method of any of embodiments A1-A10, further comprising:
   entering the connected state for the first PLMN such that the recovery procedure towards the second PLMN is pending; and
   performing the recovery procedure towards the second PLMN upon exiting the connected state for the first PLMN.
A13. The method of embodiment A12, further comprising, upon expiration of the leaving timer without receiving a responsive message from the second PLMN, performing one of the following:
   disabling or stopping one or more timer triggers for the recovery procedure towards the second PLMN; or
   refraining from taking action upon expiration of any of the timer triggers for the recover procedure towards the second PLMN.
A14. The method of any of embodiments A1-A12, wherein the recovery procedure towards the second PLMN is initiated further based on one of the following:
   relative priorities of the first PLMN and the second PLMN; or
   relative priorities of respective UE services in the first PLMN and the second PLMN.
A15. The method of any of embodiments A1-A14, further comprising, while the leaving timer is running and the UE is in the connected state for the second PLMN, refraining from performing one or more of the following operations in the second PLMN: radio link monitoring (RLM), radio resource monitoring (RRM), measurement reporting, monitoring conditional reconfiguration conditions, and sending UEAssistanceInformation messages.
A16. The method of any of embodiments A1-A15, wherein the recovery procedure is a non-access-stratum (NAS) recovery procedure, and initiating the recovery procedure comprises upon expiration of the leaving timer, sending, from the UE access stratum (AS) to the UE NAS, an indication of a reason or cause for entering the reduced-energy state for the second PLMN.
A17. The method of embodiment A16, wherein the UE NAS refrains from completing the recovery procedure towards the second PLMN until the UE exits the connected state for the first PLMN.
A18. The method of embodiment A16, wherein the UE NAS initiates the recovery procedure towards the second PLMN.
A19. The method of embodiment A18, wherein initiating the recovery procedure based on expiration of the leaving timer comprises:
   upon expiration of the leaving timer, sending, from the UE AS to the UE NAS, an indication that one or more timer triggers for the recovery procedure can be enabled; and
   enabling the one or more timer triggers by the UE NAS,
   wherein the UE NAS initiates the recovery procedure upon expiration of any of the timer triggers.
A20. The method of embodiment A16, wherein:
   the UE AS indicates, to the UE NAS, a reason or cause associated with a connection failure when the UE exits the connected state for the first PLMN; and
   the UE NAS initiates the recovery procedure upon receiving the reason or cause.
A21. The method of any of embodiments A1-A21, wherein the recovery procedure comprises establishing, re-establishing, or setting up the connected state with the second PLMN.
B1. A method for a network node of a second public land mobile networks (PLMN) to manage a user equipment (UE) configured with user credentials for a plurality of PLMNs, the method comprising:
   while the UE is registered in the second PLMN and in a first PLMN and in a connected state for the second PLMN, receiving from the UE an indication that the UE wants to enter a reduced-energy state for the second PLMN;
   initiating a leaving timer for the UE upon receiving the indication; and
   refraining from performing one or more connected-state operations with the UE while the leaving timer is running.
B2. The method of embodiment B1, further comprising sending, to the UE while the leaving timer is running, a message responsive to the indication.
B3. The method of embodiment B2, wherein the responsive message indicates that the UE should enter the reduced-energy state.
B4. The method of any of embodiments B2-B3, wherein the responsive message is one of the following: an RRCRelease message, or an RRCReconfiguration message.
B5. The method of any of embodiments B1-B4, wherein the reduced-energy state for the second PLMN is one of the following: RRC_IDLE; RRC_INACTIVE; or RRC_IDLE with stored context.
B6. The method of any of embodiments B1-B5, further comprising sending the UE a timer value in an RRCReconfiguration message or an RRCResume message, wherein the leaving timer is initiated to the timer value sent to the UE.
B7. The method of embodiment B6, wherein the timer value is included in a series of nested information elements for a Multi-SIM configuration.
B8. The method of any of embodiments B1-B7, wherein the indication that the UE wants to enter a reduced-energy state for the second PLMN is included in a UEAssistanceInformation message.
B9. The method of any of embodiments B1-B8, further comprising performing a recovery procedure with the UE after expiration of the leaving timer.
B10. The method of embodiment B9, wherein the recovery procedure is a Non-Access Stratum (NAS) recovery procedure.
B11. The method of any of embodiments B9-B10, wherein the recovery procedure comprises establishing, re-establishing, or setting up the connected state with the UE.
B12. The method of any of embodiments B9-B11, further comprising receiving, from the UE after expiration of the leaving timer, a further indication of a UE-initiated recovery procedure with the second PLMN, wherein the recovery procedure is performed in response to the further indication.
B13. The method of any of embodiments B1-B12, wherein the connected-state operations include transmitting downlink data to the UE.
C1. A user equipment (UE) configured with user credentials for a plurality of public land mobile networks (PLMNs), the UE comprising:
   communication interface circuitry configured to communicate with network nodes in first and second PLMNs; and
   processing circuitry operatively coupled to the communication interface circuitry, whereby the processing circuitry and the communication interface circuitry are configured to perform operations corresponding to the methods of any of embodiments A1-A21.
C2. A user equipment (UE) configured with user credentials for a plurality of public land mobile networks (PLMNs), the UE being further configured to perform operations corresponding to the methods of any of embodiments A1-A21.
C3. A non-transitory, computer-readable medium storing computer-executable instructions that, when executed by processing circuitry of a configured with user credentials for a plurality of public land mobile networks (PLMNs), configure the UE to perform operations corresponding to the methods of any of embodiments A1-A21.
C4. A computer program product comprising computer-executable instructions that, when executed by processing circuitry of a configured with user credentials for a plurality of public land mobile networks (PLMNs), configure the UE to perform operations corresponding to the methods of any of embodiments A1-A21.
D1. A network node, of a second public land mobile networks (PLMN), arranged to manage a user equipment (UE) configured with user credentials for a plurality of PLMNs, the network node comprising:
   communication interface circuitry configured to communicate with the UE; and
   processing circuitry operatively coupled to the communication interface circuitry, whereby the processing circuitry and the communication interface circuitry are configured to perform operations corresponding to the methods of any of embodiments B1-B13.
D2. A network node, of a second public land mobile networks (PLMN), arranged to manage a user equipment (UE) configured with user credentials for a plurality of PLMNs, the network node being further arranged to perform operations corresponding to the methods of any of embodiments B1-B13.
D3. A non-transitory, computer-readable medium storing computer-executable instructions that, when executed by processing circuitry of a network node arranged to manage a user equipment (UE) configured with user credentials for a plurality of public land mobile networks (PLMNs), configure the network node to perform operations corresponding to the methods of any of embodiments B1-B13.
D4. A computer program product comprising computer-executable instructions that, when executed by processing circuitry of a network node arranged to manage a user equipment (UE) configured with user credentials for a plurality of public land mobile networks (PLMNs), configure the network node to perform operations corresponding to the methods of any of embodiments B1-B13.

1-42. (canceled)

43. A method for a user equipment (UE) configured with user credentials for a plurality of public land mobile networks (PLMNs), the method comprising:
while registered in first and second PLMNs, in a connected state for the second PLMN, and in a reduced-energy state for the first PLMN, transmitting to the second PLMN an indication that the UE wants to enter a reduced-energy state for the second PLMN;
initiating a timer upon transmitting the indication; and
initiating a recovery procedure towards the second PLMN based on expiration of the timer without receiving a responsive message from the second PLMN.

44. The method of claim 43, wherein one or more of the following applies:
the reduced-energy state for the second PLMN is one of the following: RRC_IDLE, RRC_INACTIVE, or RRC_IDLE with stored context; and
the recovery procedure comprises establishing, re-establishing, or setting up the connected state with the second PLMN.

45. The method of claim 43, wherein the indication that the UE wants to enter a reduced-energy state for the second PLMN is transmitted in a UEAssistanceInformation message.

46. The method of claim 43, further comprising receiving a timer value from the second PLMN in an RRCReconfiguration message or an RRCResume message, wherein the timer is initiated to the received timer value.

47. The method of claim 46, wherein the timer value is included in a series of nested information elements for a multiple subscriber identity module (Multi-SIM) configuration.

48. The method of claim 43, further comprising, when the responsive message is received from the second PLMN while the timer is running, applying the contents of the responsive message and stopping the timer.

49. The method of claim 48, wherein one or more of the following applies:
the responsive message indicates that the UE should enter the reduced-energy state for the second PLMN; and
the responsive message is an RRCRelease message or an RRCReconfiguration message.

50. The method of claim 43, wherein one of more of the following applies:
the recovery procedure towards the second PLMN is a non-access stratum, NAS, recovery procedure; and
initiating the recovery procedure towards the second PLMN comprises entering a reduced-energy state for the second PLMN.

51. The method of claim 50, wherein the recovery procedure initiated towards the second PLMN is performed upon the expiration of the timer without receiving a responsive message from the second PLMN.

52. The method of claim 50, further comprising:
entering the connected state for the first PLMN such that the recovery procedure initiated towards the second PLMN is pending; and
performing the pending recovery procedure towards the second PLMN upon exiting the connected state for the first PLMN.

53. The method of claim 52, further comprising:
initiating a second timer associated with a pending recovery procedure, in response to entering the reduced-energy state for the second PLMN;
stopping the second timer in response to performing one or more of the following while the second timer is running: exiting the connected state for the first PLMN, and responding to a page from the second PLMN; and
in response to expiration of the second timer, transmitting to the first PLMN an indication that the UE wants to exit the connected state for the first PLMN.

54. The method of claim 52, further comprising, upon the expiration of the timer without receiving a responsive message from the second PLMN, performing one of the following:
disabling or stopping one or more timer triggers for the recovery procedure towards the second PLMN; or
refraining from taking action upon expiration of any of the timer triggers for the recovery procedure towards the second PLMN.

55. The method of claim 43, wherein the recovery procedure towards the second PLMN is initiated further based on one of the following:
relative priorities of the first PLMN and the second PLMN; or
relative priorities of respective UE services in the first PLMN and the second PLMN.

56. A method for a network node configured to operate in a second public land mobile network (PLMN) and to manage a user equipment (UE) configured with user credentials for a plurality of PLMNs, the method comprising:
while the UE is registered in the second PLMN and in a first PLMN and while the UE is in a connected state for the second PLMN, receiving from the UE an indication that the UE wants to enter a reduced-energy state for the second PLMN;
initiating a timer associated with the UE upon receiving the indication; and
refraining from performing one or more connected-state operations with the UE while the timer is running.

57. The method of claim 56, further comprising sending, to the UE while the timer is running, a message responsive to the indication.

58. The method of claim 57, wherein one or more of the following applies:
the responsive message indicates that the UE should enter the reduced-energy state; and
the responsive message is an RRCRelease message or an RRCReconfiguration message.

59. A user equipment (UE) configured with user credentials for a plurality of public land mobile networks (PLMNs), the UE comprising:
communication interface circuitry configured to communicate with network nodes in first and second PLMNs; and
processing circuitry operatively coupled to the communication interface circuitry, whereby the processing circuitry and the communication interface circuitry are configured to:
while registered in the first and second PLMNs, in a connected state for the second PLMN, and in a reduced-energy state for the first PLMN, transmit to the second PLMN an indication that the UE wants to enter a reduced-energy state for the second PLMN;
initiate a timer upon transmitting the indication; and
initiate a recovery procedure towards the second PLMN based on expiration of the timer without receiving a responsive message from the second PLMN.

60. The UE of claim 59, wherein the processing circuitry and the communication interface circuitry are further configured to, when the responsive message is received from the second PLMN while the timer is running, apply the contents of the responsive message and stop the timer, wherein one or more of the following applies:
the responsive message indicates that the UE should enter the reduced-energy state for the second PLMN; and
the responsive message is an RRCRelease message or an RRCReconfiguration message.

61. A network node configured to operate in a second public land mobile network (PLMN) and to manage a user equipment (UE) configured with user credentials for a plurality of PLMNs, the network node comprising:
communication interface circuitry configured to communicate with the UE; and
processing circuitry operatively coupled to the communication interface circuitry, whereby the processing circuitry and the communication interface circuitry are configured to:
while the UE is registered in the second PLMN and in a first PLMN and while the UE is in a connected state for the second PLMN, receive from the UE an indication that the UE wants to enter a reduced-energy state for the second PLMN;
initiate a timer associated with the UE upon receiving the indication; and
refrain from performing one or more connected-state operations with the UE while the timer is running.

62. The network node of claim 61, wherein the processing circuitry and the communication interface circuitry are further configured to send, to the UE while the timer is running, a message responsive to the indication, wherein one or more of the following applies:
the responsive message indicates that the UE should enter the reduced-energy state; and
the responsive message is an RRCRelease message or an RRCReconfiguration message.
